(19) United States
(12) Patent Application Publication
(10) Pub. No.: US 2009/0249032 A1
(43) Pub. Date: Oct. 1, 2009

(54) INFORMATION APPARATUS

(75) Inventors: Takashi Nishihara, Osaka (JP); Toshifumi Hamaguchi, Osaka (JP)

Correspondence Address: STEPTOE & JOHNSON LLP, 1330 CONNECTICUT AVE., NW, WASHINGTON, DC, 20036, US

(73) Assignee: Panasonic Corporation, Kadoma-shi (JP)

(21) Appl. No.: 12/392,184

(22) Filed: Feb. 25, 2009

(30) Foreign Application Priority Data
Mar. 25, 2008 (JP) 2008-076913

(51) Int. Cl. G06F 9/315

(52) U.S. Cl. 712/204; 712/E09.034

(57) ABSTRACT

An information apparatus comprises: a barrel shifter composed of a bidirectional 1-bit shifter, . . . , and a bidirectional 24-bit shifter which are connected in series; a control unit for outputting an endian conversion control signal SE indicating one of a shift operation and endian conversion; an endian conversion unit for generating data by endian conversion using data obtained by performing a shift operation in the bidirectional 8-bit shifter and the bidirectional 24-bit shifter; and a selector for selecting, when the endian conversion control signal SE indicates a shift operation, data outputted from the bidirectional 24-bit shifter, and selecting, when the endian conversion control signal SE indicates endian conversion, the data outputted from the endian conversion unit.

### FIELD OF THE INVENTION

The present invention relates to an information apparatus which performs a shift operation and endian conversion with a barrel shifter.

### BACKGROUND OF THE INVENTION

Conventionally, methods such as big endian and little endian are known as methods of arranging, on memory, data in which a word consists of multiple bytes. One of these methods has been used in widespread computers.

Big endian is a method of arranging data, in which a word consists of multiple bytes, from the most significant byte with a predetermined size on memory. Little endian is a method of arranging data, in which a word consists of multiple bytes, from the least significant byte with a predetermined size on memory.

Thus in the case of a transition from a system using big endian to a system using little endian and vice versa, problems may occur due to the arrangement of data. For example, problems may occur in the arrangement of data accessed by long word access and so on and the arrangement of addresses. For this reason, the arrangement of bytes has to be changed (hereinafter, will be referred to as endian conversion) between big endian and little endian (for example, see Japanese Patent Laid-Open No. 2000-305892).

### Configuration

The following will describe an endian converter for performing endian conversion according to the prior art.

As shown in FIG. 1, an endian converter 10 includes selectors 11, 12, 13, and 14 for replacing data. Each of the selectors selects an input source based on a control signal. When the control signal corresponding to each endian conversion mode (00, 01, 10) is inputted to each of the selectors, data portions (D[31:24], D[23:16], D[15:8], D[7:0]) selected according to the mode are outputted from each of the selectors. The endian conversion is achieved thus.

However, in order to perform endian conversion with an information apparatus such as a CPU according to the prior art, the information apparatus has to further include a dedicated circuit such as the endian converter 10. Moreover, such a dedicated circuit has to be provided for each kind of endian conversion.

### DISCLOSURE OF THE INVENTION

The present invention has been devised in view of the foregoing problem. An object of the present invention is to provide an information apparatus which performs endian conversion without further including a dedicated circuit such as an endian converter.

In order to attain the object, the information apparatus of the present invention has the following characteristics:

(a) The information apparatus comprises: (a1) a barrel shifter composed of a plurality of bit shifters connected in series in a direction of a data flow; (a2) a control unit for outputting a control signal indicating one of a first operation for bit shifting data and a second operation for converting data from first endian to second endian; (a3) an endian conversion unit for generating data by performing the second operation using data obtained by performing a shift operation in one of the bit shifters of the barrel shifter; and (a4) a selector for outputting, when the control signal indicates the first operation, data obtained by performing a shift operation in all the bit shifters of the barrel shifter, and outputting, when the control signal indicates the second operation, the data generated in the endian conversion unit.

Thus the information apparatus controls the barrel shifter which is necessary for aligning digits during the execution of a shift instruction, an operation instruction, and so on, so that a shift operation and endian conversion can be selectively performed. Consequently, it is not necessary to provide an endian converter, thereby suppressing an increase in circuit.

(b) (b1) The barrel shifter is composed of a bidirectional 1-bit shifter, a bidirectional 3-bit shifter, a bidirectional 8-bit shifter, and a bidirectional 24-bit shifter which are sequentially connected in series from a side fed with 32-bit first data, (b2) the bidirectional 1-bit shifter generates 34-bit second data by performing a shift operation on the first data, (b3) the bidirectional 3-bit shifter generates 38-bit third data by performing a shift operation on the second data, (b4) the bidirectional 8-bit shifter generates 54-bit fourth data by performing a shift operation on the third data, (b5) the bidirectional 24-bit shifter generates 32-bit fifth data by performing a shift operation on the fourth data, (b6) the endian conversion unit generates sixth data by sequentially arranging the first byte data of the fifth data, the second byte data of a portion obtained by excluding 11 bits on both sides from the fourth data, the third byte data of the fifth data, and the fourth byte data of the portion obtained by excluding 11 bits on both sides from the fourth data, and (b7) the selector outputs, when the control signal indicates the first operation, the fifth data as data obtained by performing a shift operation in all the bit shifters of the barrel shifter, and outputs, when the control signal indicates the second operation, the sixth data as data generated in the endian conversion unit.

Thus it is possible to selectively perform a shift operation of a left shift 31-bit to a right shift 31-bit and endian conversion on 32-bit data.

(c) (c1) The information apparatus further comprises a decoder for controlling a shift operation in each of the bit shifters of the barrel shifter based on the control signal outputted from the control unit, (c2) wherein (c2-1) in endian conversion on word data when the control signal indicates the second operation, the decoder causes: (c2-1a) the bidirectional 1-bit shifter to output a result of non-shift as the second data, (c2-1b) the bidirectional 3-bit shifter to output a result of non-shift as the third data, (c2-1c) the bidirectional 8-bit shifter to output a result of right rotation as the fourth data, and (c2-1d) the bidirectional 24-bit shifter to output a result of right rotation as the fifth data, and (c2-2) in endian conversion on half-word data when the control signal indicates the second operation, the decoder causes: (c2-2a) the bidirectional 1-bit shifter to output a result of non-shift as the second data, (c2-2b) the bidirectional 3-bit shifter to output a result of non-shift as the third data, (c2-2c) the bidirectional 8-bit shifter to output a result of left rotation as the fourth data, and (c2-2d) the bidirectional 24-bit shifter to output a result of left rotation as the fifth data.

Thus it is not necessary to provide an endian converter for each kind of endian conversion, thereby suppressing an increase in circuit.

(d) (d1) The barrel shifter is composed of a bidirectional 1-bit shifter, a bidirectional 3-bit shifter, a bidirectional 8-bit shifter, and a bidirectional 19-bit shifter which are sequentially connected in series from a side fed with 32-bit first data, (d2) the bidirectional 1-bit shifter generates 34-bit second data by performing a shift operation on the first data, (d3) the bidirectional 3-bit shifter generates 38-bit third data by performing a shift operation on the second data, (d4) the bidirectional 8-bit shifter generates 44-bit fourth data by performing a shift operation on the third data, (d5) the bidirectional 19-bit shifter generates 32-bit fifth data by performing a shift operation on the fourth data, (d6) the endian conversion unit generates sixth data by sequentially arranging the third byte data, the second byte data, the first byte data, and the fourth byte data of a portion obtained by excluding six bits on both sides from the fourth data, and (d7) the selector outputs, when the control signal indicates the first operation, the fifth data as data obtained by performing a shift operation in all the bit shifters of the barrel shifter, and outputs, when the control signal indicates the second operation, the sixth data as the data generated in the endian conversion unit.

Thus it is possible to selectively perform a shift operation of a left shift 31-bit to a right shift 31-bit and endian conversion on 32-bit data.

(e) (e1) The information apparatus further comprises a decoder for controlling a shift operation in each of the bit shifters of the barrel shifter based on the control signal outputted from the control unit, (e2) wherein (e2-1) in endian conversion on word data when the control signal indicates the second operation, the decoder causes: (e2-1a) the bidirectional 1-bit shifter to output a result of non-shift as the second data, (e2-1b) the bidirectional 3-bit shifter to output a result of non-shift as the third data, (e2-1c) the bidirectional 8-bit shifter to output a result of right rotation as the fourth data, and (e2-1d) the bidirectional 19-bit shifter to output a result of non-shift as the fifth data, and (e2-2) in endian conversion on half-word data when the control signal indicates the second operation, the decoder causes: (e2-2a) the bidirectional 1-bit shifter to output a result of non-shift as the second data, (e2-2b) the bidirectional 3-bit shifter to output a result of non-shift as the third data, (e2-2c) the bidirectional 8-bit shifter to output a result of left rotation as the fourth data, and (e2-2d) the bidirectional 19-bit shifter to output a result of non-shift as the fifth data.

Thus it is not necessary to provide an endian converter for each kind of endian conversion, thereby suppressing an increase in circuit.

As has been discussed, according to the present invention, the information apparatus controls the barrel shifter which is necessary for aligning digits during the execution of a shift instruction, an operation instruction, and so on, so that a shift operation and endian conversion can be selectively performed. Consequently, it is not necessary to provide an endian converter, thereby suppressing an increase in circuit. Further, it is not necessary to provide an endian converter for each kind of endian conversion, thereby suppressing an increase in circuit.

### BRIEF DESCRIPTION OF THE DRAWINGS

FIG. 1 is a block diagram showing the configuration of an endian converter according to the prior art;

FIG. 2 is a block diagram showing the configuration of an information apparatus according to a first embodiment;

FIG. 3 is a first drawing showing a truth table of control signals for controlling the information apparatus according to the first embodiment;

FIG. 4 is a second drawing showing a truth table of the control signals for controlling the information apparatus according to the first embodiment;

FIG. 5A shows the outline of word endian conversion;

FIG. 5B shows the outline of half-word endian conversion;

FIG. 6 is a block diagram showing the configuration of an information apparatus according to a second embodiment;

FIG. 7 is a first drawing showing a truth table of control signals for controlling the information apparatus according to the second embodiment; and

FIG. 8 is a second drawing showing a truth table of the control signals for controlling the information apparatus according to the second embodiment.

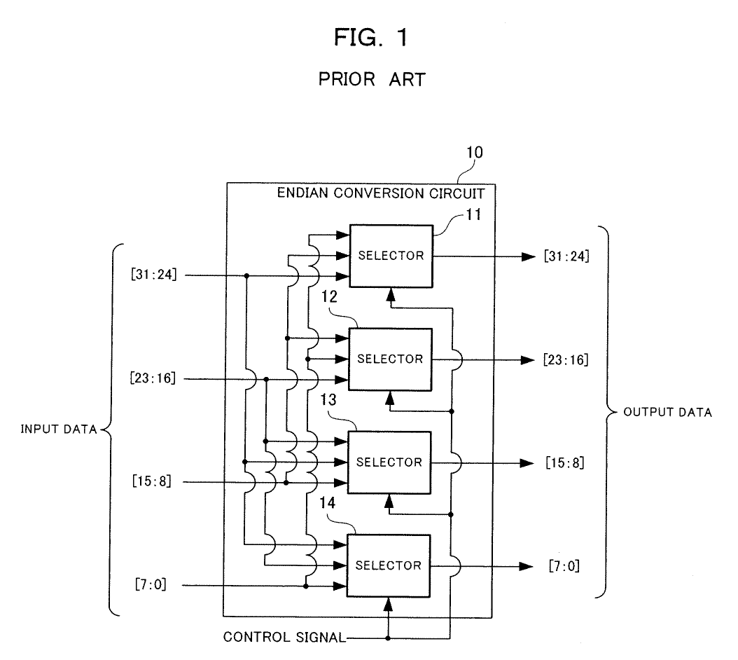

### DESCRIPTION OF THE EMBODIMENTS

### First Embodiment

A first embodiment of the present invention will be described below.

### <Outline>

An information apparatus of the present embodiment has the following characteristics (a) to (c):

(a) The information apparatus comproses: (a1) a barrel shifter composed of a plurality of bit shifters connected in series in a direction of a data flow; (a2) a control unit for outputting a control signal indicating one of a first operation for bit shifting data and a second operation for converting data from first endian to second endian; (a3) an endian conversion unit for generating data by performing the second operation using data obtained by performing a shift operation in one of the bit shifters of the barrel shifter; and (a4) a selector for outputting, when the control signal indicates the first operation, data obtained by performing a shift operation in all the bit shifters of the barrel shifter, and outputting, when the control signal indicates the second operation, the data generated in the endian conversion unit.
(b) (b1) The barrel shifter is composed of a bidirectional 1-bit shifter, a bidirectional 3-bit shifter, a bidirectional 8-bit shifter, and a bidirectional 24-bit shifter which are sequentially connected in series from a side fed with 32-bit first data, (b2) the bidirectional 1-bit shifter generates 34-bit second data by performing a shift operation on the first data, (b3) the bidirectional 3-bit shifter generates 38-bit third data by performing a shift operation on the second data, (b4) the bidirectional 8-bit shifter generates 54-bit fourth data by performing a shift operation on the third data, (b5) the bidirectional 24-bit shifter generates 32-bit fifth data by performing a shift operation on the fourth data, (b6) the endian conversion unit generates sixth data by sequentially arranging the first byte data of the fifth data, the second byte data of a portion obtained by excluding 11 bits on both sides from the fourth data, the third byte data of the fifth data, and the fourth byte data of the portion obtained by excluding 11 bits on both sides from the fourth data, and (b7) the selector outputs, when the control signal indicates the first operation, the fifth data as data obtained by performing a shift operation in all the bit shifters of the barrel shifter, and outputs, when the control signal indicates the second operation, the sixth data as the data generated in the endian conversion unit.
(c) (c1) The information apparatus further comprises a decoder for controlling a shift operation in each of the bit shifters of the barrel shifter based on the control signal outputted from the control unit, (c2) wherein (c2-1) in endian conversion on word data when the control signal indicates the second operation, the decoder causes: (c2-1a) the bidirectional 1-bit shifter to output a result of non-shift as the second data, (c2-1b) the bidirectional 3-bit shifter to output a result of non-shift as the third data, (c2-1c) the bidirectional 8-bit shifter to output a result of right rotation as the fourth data, and (c2-1d) the bidirectional 24-bit shifter to output a result of right rotation as the fifth data, and (c2-2) in endian conversion on half-word data when the control signal indicates the second operation, the decoder causes: (c2-2a) the bidirectional 1-bit shifter to output a result of non-shift as the second data, (c2-2b) the bidirectional 3-bit shifter to output a result of non-shift as the third data, (c2-2c) the bidirectional 8-bit shifter to output a result of left rotation as the fourth data, and (c2-2d) the bidirectional 24-bit shifter to output a result of left rotation as the fifth data.

In view of the foregoing points, the present embodiment will be described below with reference to the accompanying drawings.

### Configuration

The following will first describe the configuration of the information apparatus according to the present embodiment.

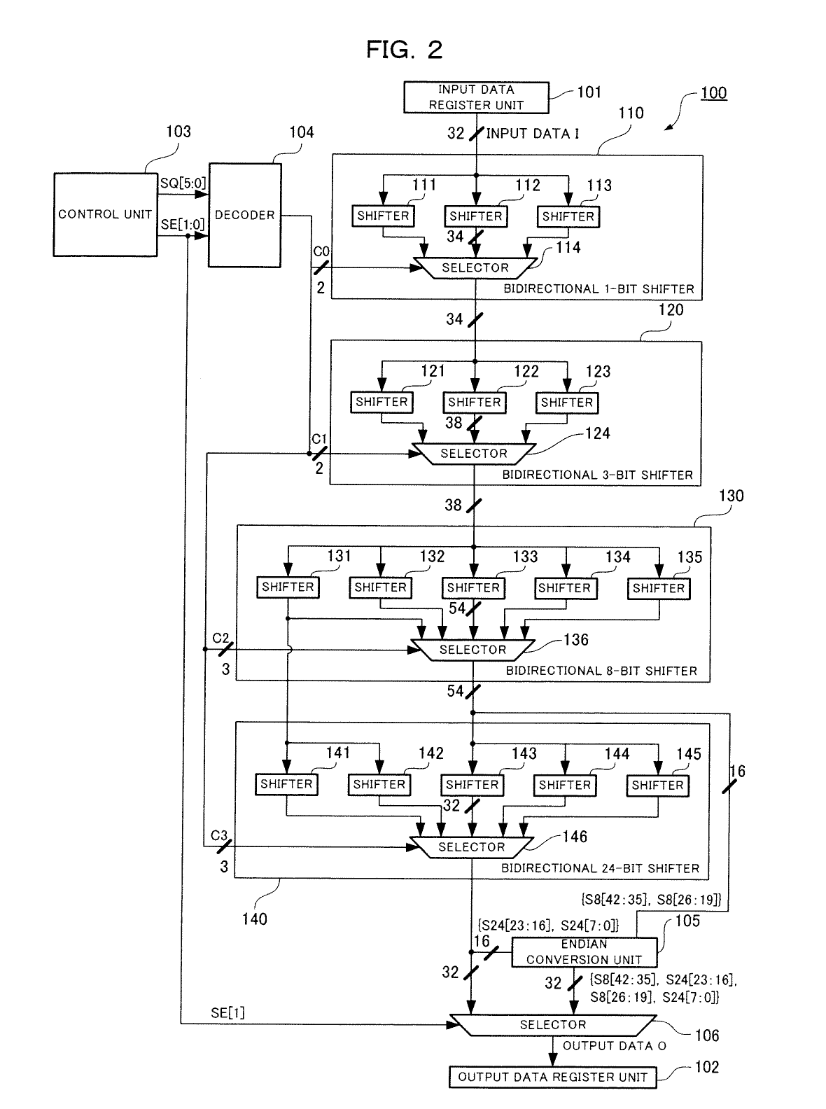

As shown in FIG. 2, an information apparatus 100 is an information apparatus such as a CPU. By sharing a barrel shifter included in the information apparatus such as a CPU, it is possible to selectively perform a shift operation for the bit shifting of data and endian conversion for the conversion of data from first endian to second endian. The shift operation and the endian conversion cannot be performed at the same time.

For example, the information apparatus 100 includes an input data register unit 101, an output data register unit 102, a control unit 103, a decoder 104, an endian conversion unit 105, a selector 106, a bidirectional 1-bit shifter 110, a bidirectional 3-bit shifter 120, a bidirectional 8-bit shifter 130, and a bidirectional 24-bit shifter 140. Further, 32-bit data is handled by the information apparatus 100.

The barrel shifter is composed of the bidirectional 1-bit shifter 110, the bidirectional 3-bit shifter 120, the bidirectional 8-bit shifter 130, and the bidirectional 24-bit shifter 140 which are sequentially connected in series. The barrel shifter can perform a shift operation of a left shift 31-bit to a right shift 31-bit.

The bidirectional 1-bit shifter 110, the bidirectional 3-bit shifter 120, the bidirectional 8-bit shifter 130, and the bidirectional 24-bit shifter 140 are respectively controlled by selector control signals C0, C1, C2, and C3 outputted from the decoder 104. Thus the barrel shifter can shift input data I by a shift quantity specified by a shift quantity control signal SQ.

### <Input Data Register Unit 101>

The input data register unit 101 can store at least 32-bit data.

### <Output Data Register Unit 102>

The output data register unit 102 can store at least 32-bit data.

### <Control Unit 103>

The control unit 103 outputs the 6-bit shift quantity control signal SQ indicating a shift direction and a shift quantity according to the kind of endian conversion and a 2-bit endian control signal SE indicating the presence or absence of endian conversion and the kind of endian conversion.

The control unit 103 may be realized by a circuit or a program executed in the information apparatus 100.

### <Decoder 104>

The decoder 104 generates the selector control signals C0, C1, C2, and C3 based on the shift quantity control signal SQ and the endian control signal SE which are outputted from the control unit 103, and outputs the generated selector control signals C0, C1, C2, and C3.

The selector control signal C0 is a 2-bit signal for controlling a selector 114 in the bidirectional 1-bit shifter 110. The selector control signal C1 is a 2-bit signal for controlling a selector 124 in the bidirectional 3-bit shifter 120. The selector control signal C2 is a 3-bit signal for controlling a selector 136 in the bidirectional 8-bit shifter 130. The selector control signal C3 is a 3-bit signal for controlling a selector 146 in the bidirectional 24-bit shifter 140.

### <Endian Conversion Unit 105>

The endian conversion unit 105 generates 32-bit data from data {S8 [42:35], S8 [26:19]} and data {S24 [23:16], S24 [7:0]} according to the pattern of wiring, and outputs the generated 32-bit data.

At this point, the endian conversion unit 105 generates the 32-bit data {S8 [42:35], S24 [23:16], S8 [26:19], S24 [7:0]} by sequentially arranging data S24 [7:0], data S8 [26:19], data S24 [23:16], and data S8 [42:35] from the lowest order byte.

The data {S8 [42:35], S8 [26:19]} is 16-bit data obtained by extracting a portion (S8 [42:35]) from the 42nd bit to the 35th bit and a portion (S8 [26:19]) from the 26th bit to the 19th bit from 54-bit data S8 outputted from the selector 136. The data {S24 [23:16], S24 [7:0]} is 16-bit data obtained by extracting a portion (S24 [23:16]) from the 23rd bit to the 16th bit and a portion (S24 [7:0]) from the 7th bit to 0th bit from 32-bit data S24 outputted from the selector 146.

### <Selector 106>

The selector 106 selects one of the bidirectional 24-bit shifter 140 and the endian conversion unit 105 as an input source based on an endian control signal SE[1] extracted from the endian control signal SE having been outputted from the control unit 103, and outputs 32-bit data having been outputted from the selected input source.

### <Bidirectional 1-Bit Shifter 110>

The bidirectional 1-bit shifter 110 includes shifters 111, 112, and 113, and the selector 114. The bidirectional 1-bit shifter 110 generates 34-bit data from 32-bit data outputted from the input data register unit 101, and outputs the generated 34-bit data.

At this point, the shifter 111 does not shift the 32-bit data outputted from the input data register unit 101 but adds one bit to both sides of the data (two bits in total), so that the 34-bit data is generated.

The shifter 112 shifts, to the left by one bit, the 32-bit data outputted from the input data register unit 101, so that the 34-bit data is generated.

The shifter 113 shifts, to the right by one bit, the 32-bit data outputted from the input data register unit 101, so that the 34-bit data is generated.

The selector 114 selects one of the shifters 111, 112, and 113 as an input source based on the selector control signal C0 outputted from the decoder 104, and outputs the 34-bit data generated by the selected input source.

For example, when the selector control signal C0 indicates “non-shift”, the selector 114 selects the shifter 111 as an input source. When the selector control signal C0 indicates “left shift”, the selector 114 selects the shifter 112 as an input source. When the selector control signal C0 indicates “right shift”, the selector 114 selects the shifter 113 as an input source.

<Bidirectional 3-Bit shifter 120>

The bidirectional 3-bit shifter 120 includes shifters 121, 122, and 123 and the selector 124. The bidirectional 3-bit shifter 120 generates 38-bit data from the 34-bit data outputted from the bidirectional 1-bit shifter 110, and outputs the generated 38-bit data.

At this point, the shifter 121 does not shift the 34-bit data outputted from the selector 114 but adds two bits to both sides of the data (four bits in total), so that the 38-bit data is generated.

The shifter 122 shifts, to the left by three bits, the 34-bit data outputted from the selector 114, so that the 38-bit data is generated.

The shifter 123 shifts, to the right by three bits, the 34-bit data outputted from the selector 114, so that the 38-bit data is generated.

The selector 124 selects one of the shifters 121, 122, and 123 as an input source based on the selector control signal C1 outputted from the decoder 104, and outputs the 38-bit data generated by the selected input source.

For example, when the selector control signal C1 indicates “non-shift”, the selector 124 selects the shifter 121 as an input source. When the selector control signal C1 indicates “left shift”, the selector 124 selects the shifter 122 as an input source. When the selector control signal C1 indicates “right shift”, the selector 124 selects the shifter 123 as an input source.

### <Bidirectional 8-Bit Shifter 130>

The bidirectional 8-bit shifter 130 includes shifters 131, 132, 133, 134, and 135, and the selector 136. The bidirectional 8-bit shifter 130 generates 54-bit data from the 38-bit data outputted from the bidirectional 3-bit shifter 120, and outputs the generated 54-bit data.

At this point, the shifter 131 does not shift the 38-bit data outputted from the selector 124 but adds eight bits to both sides of the data (16 bits in total), so that the 54-bit data is generated.

The shifter 132 shifts, to the left by eight bits, the 38-bit data outputted from the selector 124, so that the 54-bit data is generated.

The shifter 133 shifts, to the right by eight bits, the 38-bit data outputted from the selector 124, so that the 54-bit data is generated.

The shifter 134 rotates, to the left by eight bits, only a portion (32-bit data) other than three bits on both sides of the 38-bit data outputted from the selector 124, so that the 54-bit data is generated.

The shifter 135 rotates, to the right by eight bits, only the portion (32-bit data) other than three bits on both sides of the 38-bit data outputted from the selector 124, so that the 54-bit data is generated.

The selector 136 selects one of the shifters 131,132, 133, 134, and 135 as an input source based on the selector control signal C2 outputted from the decoder 104, and outputs the 54-bit data generated by the selected input source.

For example, when the selector control signal C2 indicates “non-shift”, the selector 136 selects the shifter 131 as an input source. When the selector control signal C2 indicates “left shift”, the selector 136 selects the shifter 132 as an input source. When the selector control signal C2 indicates “right shift”, the selector 136 selects the shifter 133 as an input source. When the selector control signal C2 indicates “left rotation”, the selector 136 selects the shifter 134 as an input source. When the selector control signal C2 indicates “right rotation”, the selector 136 selects the shifter 135 as an input source.

The shifter 131 outputs the generated 54-bit data also to the shifters 141 and 142 in the bidirectional 24-bit shifter 140 as well as the selector 136.

### <Bidirectional 24-Bit Shifter 140>

The bidirectional 24-bit shifter 140 includes the shifters 141 and 142, shifters 143, 144, and 145, and the selector 146. The bidirectional 24-bit shifter 140 generates 32-bit data from the 54-bit data outputted from the bidirectional 8-bit shifter 130, and outputs the generated 32-bit data.

At this point, the shifter 141 rotates, to the left by 24 bits, only a portion (32-bit data) other than 11 bits on both sides of the 54-bit data outputted from the shifter 131, and deletes 11 bits from both sides of the data (22 bits in total), so that the 32-bit data is generated.

The shifter 142 rotates, to the right by 24 bits, only a portion (32-bit data) other than 11 bits on both sides of the 54-bit data outputted from the shifter 131, and deletes 11 bits from both sides of the data (22 bits in total), so that 32-bit data is generated.

The shifter 143 does not shift the 54-bit data outputted from the selector 136 but deletes 11 bits from both sides of the data (22 bits in total), so that 32-bit data is generated.

The shifter 144 shifts, to the left by 24 bits, the 54-bit data outputted from the selector 136, and deletes 11 bits from both sides of the data (22 bits in total), so that 32-bit data is generated.

The shifter 145 shifts, to the right by 24 bits, the 54-bit data outputted from the selector 136, and deletes 11 bits from both sides of the data (22 bits in total), so that 32-bit data is generated.

The selector 146 selects one of the shifters 141, 142, 143, 144, and 145 as an input source based on the selector control signal C3 outputted from the decoder 104, and outputs the 32-bit data generated by the selected input source.

For example, when the selector control signal C3 indicates “left rotation”, the selector 146 selects the shifter 141 as an input source. When the selector control signal C3 indicates “right rotation”, the selector 146 selects the shifter 142 as an input source. When the selector control signal C3 indicates “non-shift”, the selector 146 selects the shifter 143 as an input source. When the selector control signal C3 indicates “left shift”, the selector 146 selects the shifter 144 as an input source. When the selector control signal C3 indicates “right shift”, the selector 146 selects the shifter 145 as an input source.

### <Operation>

With this operation, the 32-bit data (input data I) stored in the input data register unit 101 passes through the bidirectional 1-bit shifter 110, the bidirectional 3-bit shifter 120, the bidirectional 8-bit shifter 130, the bidirectional 24-bit shifter 140, and the selector 106, so that one of a shift operation and endian conversion is performed on the data. The 32-bit data (output data O) obtained by one of the shift operation and endian conversion is stored in the output data register unit 102.

### <Barrel Shifter>

The following will describe the barrel shifter included in the information apparatus 100.

In the barrel shifter included in the information apparatus 100, necessary data is obtained by a combination of a right shift and a left shift. However, data in the bit shifter has to be outputted to the subsequent bit shifter with data to be shifted out. Thus the data outputted from the bit shifter includes unnecessary bits (hereinafter, will be referred to as additional bits).

For example, in the barrel shifter, data shifted to the right by 13 bits can be obtained by the following operations (1) to (4):

(1) The bidirectional 1-bit shifter 110 does not shift the data.
(2) The bidirectional 3-bit shifter 120 shifts the data to the left by three bits.
(3) The bidirectional 8-bit shifter 130 shifts the data to the left by eight bits.
(4) The bidirectional 24-bit shifter 140 shifts the data to the right by 24 bits.

In this example, since the data is shifted to the left by 11 bits and then is shifted to the right by 24 bits, it is necessary to leave 11 bits on the left. For this reason, in the bidirectional 3-bit shifter 120, it is necessary to expand the output side to the left by three bits relative to the input side. Further, in the bidirectional 8-bit shifter 130, it is necessary to expand the output side to the left by 11 bits relative to the input side.

In order to perform a shift operation of a left shift 31-bit to a right shift 31-bit, the following operations (1) to (3) are performed:

(1) In the bidirectional 1-bit shifter 110, the output side is expanded to both sides by one bit relative to the input side.
(2) In the bidirectional 3-bit shifter 120, the output side is expanded to both sides by two bits relative to the input side.
(3) In the bidirectional 8-bit shifter 130, the output side is expanded to both sides by eight bits relative to the input side.

In this case, in the data outputted from the bit shifters, portions corresponding to the 32-bit data (input data I) are obtained as will be described in (1) to (4) below.

(1) The data outputted from the bidirectional 1-bit shifter 110 includes additional bits (one bit on both sides). Thus the corresponding portion in the data outputted from the bidirectional 1-bit shifter 110 is data [32:1] other than the additional bits (one bit on both sides).
(2) The data outputted from the bidirectional 3-bit shifter 120 includes additional bits (three bits on both sides). Thus the corresponding portion in the data outputted from the bidirectional 3-bit shifter 120 is data [34:3] other than the additional bits (three bits on both sides).
(3) The data outputted from the bidirectional 8-bit shifter 130 includes additional bits (eleven bits on both sides). Thus the corresponding portion in the data outputted from the bidirectional 8-bit shifter 130 is data [42:11] other than the additional bits (eleven bits on both sides).
(4) The data outputted from the bidirectional 24-bit shifter 140 does not include additional bits. Thus the corresponding portion in the data outputted from the bidirectional 24-bit shifter 140 is data [31:0].

### <Truth Table>

The following will describe the truth table of the control signals as to operations indicating the actions of the information apparatus 100.

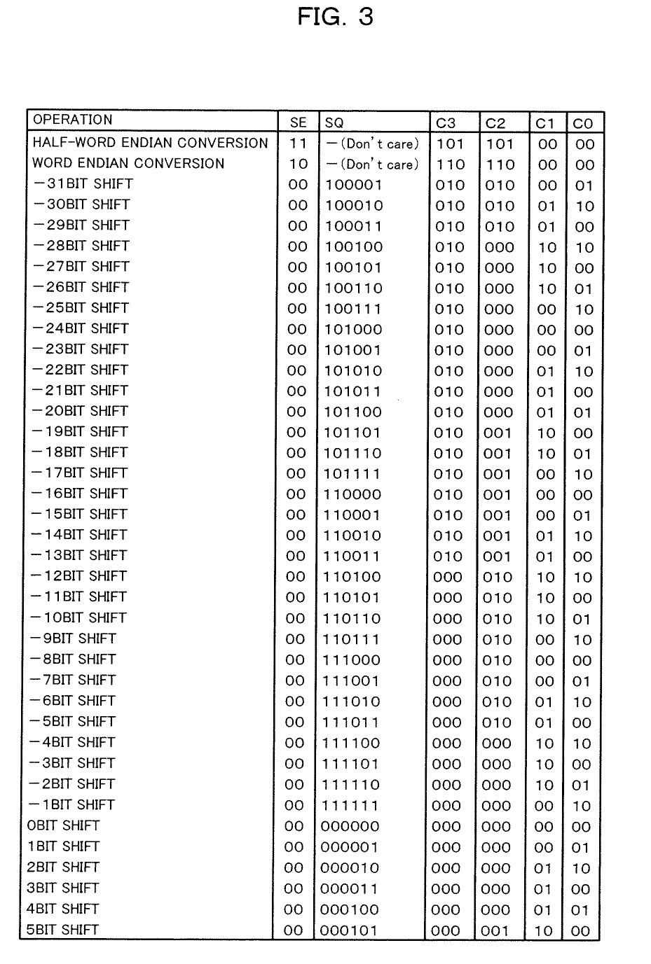

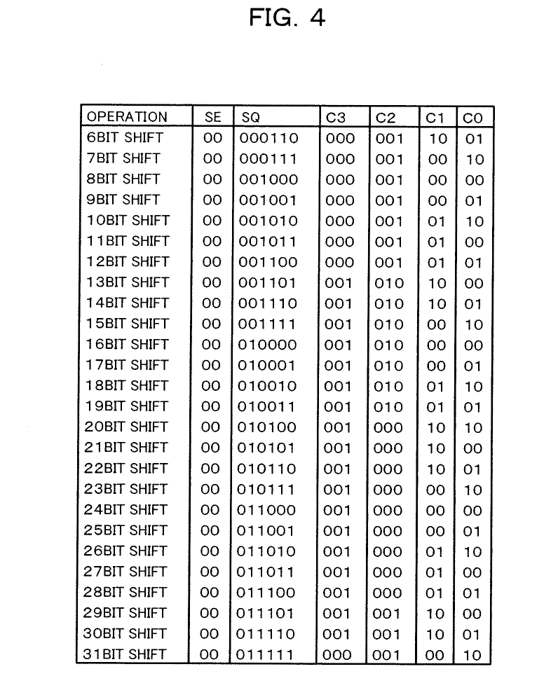

FIG. 3 shows the truth table of the control signals as to endian conversion on half-word data (hereinafter, will be referred to as half-word endian conversion), endian conversion on word data (hereinafter, will be referred to as word endian conversion), and a shift operation of a right shift 31-bit to a left shift 5-bit. FIG. 4 shows the truth table of the control signals as to a shift operation of a left shift 6-bit to a left shift 31-bit.

The truth values of the shift quantity control signal SQ are uniquely assigned values of −31 to 31. In this case, negative numbers indicate right shifts and positive numbers indicate left shifts.

As shown in FIGS. 3 and 4, as to the selector control signals C0 and C1, “00” represents “non-shift”, “01” represents “left shift”, and “10” represents “right shift”. As to the selector control signals C2 and C3, “000” represents “non-shift”, “001” represents “left shift”, “010” represents “right shift”, “101” represents “left rotation”, and “110” represents “right rotation”. As to the endian control signal SE, “11” represents “half-word endian conversion” and “10” represents “word endian conversion”.

For example, in a shift operation, the control unit 103 outputs the endian control signal SE(00). In endian conversion, the control unit 103 outputs the endian control signal SE (one of 10 and 11).

At this point, in the case of word endian conversion, the control unit 103 outputs the endian control signal SE(10) to the decoder 104. Accordingly, the decoder 104 outputs the selector control signal C2(110) to the bidirectional 8-bit shifter 130. The bidirectional 8-bit shifter 130 is caused to output data of an 8-bit right rotation. The decoder 104 outputs the selector control signal C3(110) to the bidirectional 24-bit shifter 140. The bidirectional 24-bit shifter 140 is caused to output data of a 24-bit right rotation.

In the case of half-word endian conversion, the control unit 103 outputs the endian control signal SE(11) to the decoder 104. Accordingly, the decoder 104 outputs the selector control signal C2(101) to the bidirectional 8-bit shifter 130. The bidirectional 8-bit shifter 130 is caused to output data of an 8-bit left rotation. The decoder 104 outputs the selector control signal C3(101) to the bidirectional 24-bit shifter 140. The bidirectional 24-bit shifter 140 is caused to output data of a 24-bit left rotation.

When the value of the endian control signal SE[1] is “0”, the selector 106 selects the bidirectional 24-bit shifter 140 as an input source. When the value of the endian control signal SE[1] is “1”, the selector 106 selects the endian conversion unit 105 as an input source.

### <Endian Conversion>

The following will describe endian conversion in the information apparatus 100.

First, the endian conversion unit 105 is fed with the fourth byte (S8 [42:35]) and the second byte (S8 [26:19]) in 32-bit data S8 [42:11] obtained by excluding the additional bits (11 bits on both sides) from the data outputted from the bidirectional 8-bit shifter 130. Further, the endian conversion unit 105 is fed with the third byte (S24 [23:16]) and the first byte (S24 [7:0]) in 32-bit data S24 [31:0] outputted from the bidirectional 24-bit shifter 140.

Accordingly, the endian conversion unit 105 generates data by sequentially arranging the inputted data from the least significant byte such that the first byte of the data S24 (S24 [7:0]), the second byte of the data S8 (S8 [26:19]), the third byte of the data S24 (S24 [23:16]), and the fourth byte of the data S8 (S8 [42:35]) are sequentially arranged.

Thus from the endian conversion unit 105, data {S8 [42:35], S24 [23:16], S8 [26:19], S24 [7:0]} is outputted.

### <Word Endian Conversion>

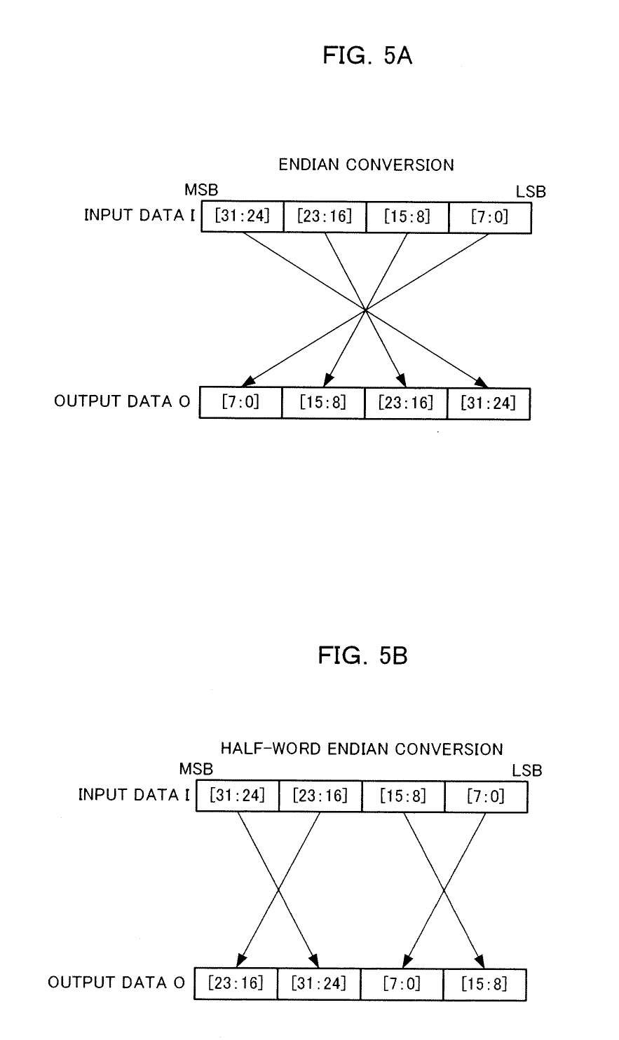

At this point, as shown in FIG. 5A, word endian conversion is performed as will be described in (1) to (4) below.

(1) The fourth byte data in the input data I is placed as the first byte data in the output data O.
(2) The third byte data in the input data I is placed as the second byte data in the output data O.
(3) The second byte data in the input data I is placed as the third byte data in the output data O.
(4) The first byte data in the input data I is placed as the fourth byte data in the output data O.

For example, when expressed in the input data I, data {I[7:0], I[15:8], I[23:16], I[31:24]} is outputted from the endian conversion unit 105. In other words, it is possible to obtain a result of word endian conversion on the input data I.

### <Half-Word Endian Conversion>

Half-word endian conversion is performed as shown in FIG. 5B.

(1) The second byte data in the input data I is placed as the first byte data in the output data O.
(2) The first byte data in the input data I is placed as the second byte data in the output data O.
(3) The fourth byte data in the input data I is placed as the third byte data in the output data O.
(4) The third byte data in the input data I is placed as the fourth byte data in the output data O.

For example, when expressed in the input data I, data {I[23:16], I[31:24], I[7:0], I[15:8]} is outputted from the endian conversion unit 105. In other words, it is possible to obtain a result of half-word endian conversion on the input data I.

### Conclusion

As has been discussed, according to the present embodiment, the information apparatus 100 controls the barrel shifter, which is necessary for aligning digits during the execution of a shift instruction, an operation instruction, and so on, by means of the control unit 103, the decoder 104, and the selector 106, so that a shift operation and endian conversion can be selectively performed. Consequently, it is not necessary to provide an endian converter, thereby suppressing an increase in circuit. Further, it is not necessary to provide an endian converter for each kind of endian conversion, thereby suppressing an increase in circuit.

### Second Embodiment

A second embodiment of the present invention will be described below.

### <Outline>

An information apparatus of the present embodiment has the following characteristics (d) and (e):

(d) (d1) A barrel shifter is composed of a bidirectional 1-bit shifter, a bidirectional 3-bit shifter, a bidirectional 8-bit shifter, and a bidirectional 19-bit shifter which are sequentially connected in series from a side fed with 32-bit first data, (d2) the bidirectional 1-bit shifter generates 34-bit second data by performing a shift operation on the first data, (d3) the bidirectional 3-bit shifter generates 38-bit third data by performing a shift operation on the second data, (d4) the bidirectional 8-bit shifter generates 44-bit fourth data by performing a shift operation on the third data, (d5) the bidirectional 19-bit shifter generates 32-bit fifth data by performing a shift operation on the fourth data, (d6) the endian conversion unit generates sixth data by sequentially arranging third byte data, second byte data, first byte data, and fourth byte data of a portion obtained by excluding six bits on both sides from the fourth data, and (d7) the selector outputs, when a control signal indicates the first operation, the fifth data as data obtained by performing a shift operation in all the bit shifters of the barrel shifter, and outputs, when the control signal indicates the second operation, the sixth data as the data generated in the endian conversion unit.
(e) (e1) The information apparatus further comprises a decoder for controlling a shift operation in each of the bit shifters of the barrel shifter based on the control signal outputted from the control unit, (e2) wherein (e2-1) in endian conversion on word data when the control signal indicates the second operation, the decoder causes: (e2-1a) the bidirectional 1-bit shifter to output a result of non-shift as the second data, (e2-1b) the bidirectional 3-bit shifter to output a result of non-shift as the third data, (e2-1c) the bidirectional 8-bit shifter to output a result of right rotation as the fourth data, and (e2-1d) the bidirectional 19-bit shifter to output a result of non-shift as the fifth data, and (e2-2) in endian conversion on half-word data when the control signal indicates the second operation, the decoder causes: (e2-2a) the bidirectional 1-bit shifter to output a result of non-shift as the second data, (e2-2b) the bidirectional 3-bit shifter to output a result of non-shift as the third data, (e2-2c) the bidirectional 8-bit shifter to output a result of left rotation as the fourth data, and (e2-2d) the bidirectional 19-bit shifter to output a result of non-shift as the fifth data.

In view of these points, the present embodiment will be described below with reference to the accompanying drawings. The same constituent elements as in the first embodiment will be indicated by the same reference numerals and the explanation thereof is omitted.

### Configuration

The following will first describe the configuration of the information apparatus according to the present embodiment.

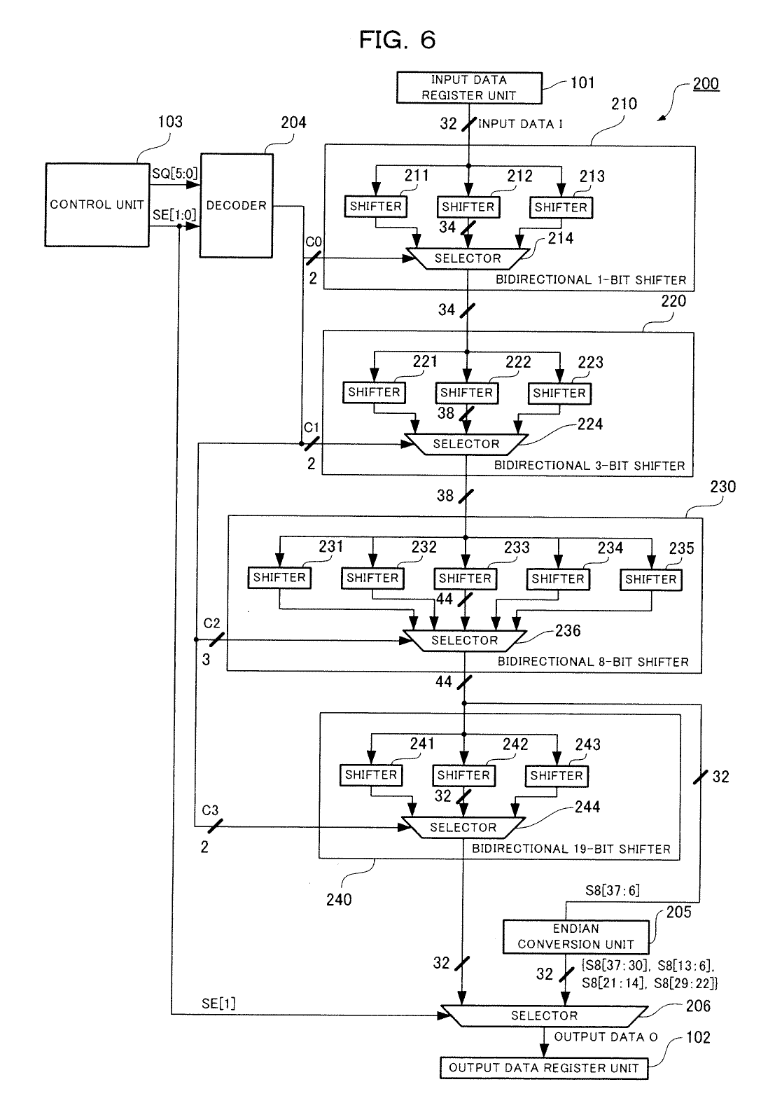

As shown in FIG. 6, an information apparatus 200 is different from the information apparatus 100 of the first embodiment in the following points:

The information apparatus 200 includes a decoder 204, an endian conversion unit 205, a selector 206, a bidirectional 1-bit shifter 210, a bidirectional 3-bit shifter 220, a bidirectional 8-bit shifter 230, and a bidirectional 19-bit shifter 240 instead of the decoder 104, the endian conversion unit 105, the selector 106, the bidirectional 1-bit shifter 110, the bidirectional 3-bit shifter 120, the bidirectional 8-bit shifter 130, and the bidirectional 24-bit shifter 140.

The barrel shifter is composed of the bidirectional 1-bit shifter 210, the bidirectional 3-bit shifter 220, the bidirectional 8-bit shifter 230, and the bidirectional 19-bit shifter 240 which are sequentially connected in series. The barrel shifter can perform a shift operation of a left shift 31-bit to a right shift 31-bit.

The bidirectional 1-bit shifter 210, the bidirectional 3-bit shifter 220, the bidirectional 8-bit shifter 230, and the bidirectional 19-bit shifter 240 are respectively controlled by selector control signals C0, C1, C2, and C3 outputted from the decoder 204. Thus the barrel shifter can shift input data I by a shift quantity specified by a shift quantity control signal SQ.

### <Decoder 204>

The decoder 204 generates the selector control signals C0, C1, C2, and C3 based on the shift quantity control signal SQ and an endian control signal SE which are outputted from a control unit 103, and outputs the generated selector control signals C0, C1, C2, and C3.

The selector control signal C0 is a 2-bit signal for controlling a selector 214 in the bidirectional 1-bit shifter 210. The selector control signal C1 is a 2-bit signal for controlling a selector 224 in the bidirectional 3-bit shifter 220. The selector control signal C2 is a 3-bit signal for controlling a selector 236 in the bidirectional 8-bit shifter 230. The selector control signal C3 is a 2-bit signal for controlling a selector 244 in the bidirectional 19-bit shifter 240.

### <Endian Conversion Unit 205>

The endian conversion unit 205 generates 32-bit data from data S8 [37:6] according to the pattern of wiring, and outputs the generated 32-bit data.

At this point, the endian conversion unit 205 generates the 32-bit data {S8 [37:30], S8 [13:6], S8 [21:14] S8 [29:22]} by sequentially arranging the third byte (S8 [29:22]), the second byte (S8 [21:14]), the first byte (S8 [13:6]), and the fourth byte (S8 [37:30]) of the data S8 [37:6] from the lowest order byte.

The data S8 [37:6] is 32-bit data obtained by extracting a portion (S8 [37:6]) from the 37th bit to the 6th bit from 44-bit data S8 outputted from the selector 236.

### <Selector 206>

The selector 206 selects one of the bidirectional 19-bit shifter 240 and the endian conversion unit 205 as an input source based on an endian control signal SE[1] extracted from the endian control signal SE having been outputted from the control unit 103, and outputs 32-bit data having been outputted from the selected input source.

### <Bidirectional 1-Bit Shifter 210>

The bidirectional 1-bit shifter 210 includes shifters 211, 212, and 213, and the selector 214. The bidirectional 1-bit shifter 210 generates 34-bit data from 32-bit data outputted from the input data register unit 101, and outputs the generated 34-bit data.

At this point, the shifter 211 does not shift the 32-bit data outputted from the input data register unit 101 but adds one bit to both sides of the data (two bits in total), so that the 34-bit data is generated.

The shifter 212 shifts, to the left by one bit, the 32-bit data outputted from the input data register unit 101, so that the 34-bit data is generated.

The shifter 213 shifts, to the right by one bit, the 32-bit data outputted from the input data register unit 101, so that the 34-bit data is generated.

The selector 214 selects one of the shifters 211, 212, and 213 as an input source based on the selector control signal C0 outputted from the decoder 204, and outputs the 34-bit data generated by the selected input source.

For example, when the selector control signal C0 indicates “non-shift”, the selector 214 selects the shifter 211 as an input source. When the selector control signal C0 indicates “left shift”, the selector 214 selects the shifter 212 as an input source. When the selector control signal C0 indicates “right shift”, the selector 214 selects the shifter 213 as an input source.

### <Bidirectional 3-Bit Shifter 220>

The bidirectional 3-bit shifter 220 includes shifters 221, 222, and 223 and the selector 224. The bidirectional 3-bit shifter 220 generates 38-bit data from the 34-bit data outputted from the bidirectional 1-bit shifter 210, and outputs the generated 38-bit data.

At this point, the shifter 221 does not shift the 34-bit data outputted from the selector 214 but adds two bits to both sides of the data (four bits in total), so that the 38-bit data is generated.

The shifter 222 shifts, to the left by three bits, the 34-bit data outputted from the selector 214, so that the 38-bit data is generated.

The shifter 223 shifts, to the right by three bits, the 34-bit data outputted from the selector 214, so that the 38-bit data is generated.

The selector 224 selects one of the shifters 221, 222, and 223 as an input source based on the selector control signal C1 outputted from the decoder 204, and outputs the 38-bit data generated by the selected input source.

For example, when the selector control signal C1 indicates “non-shift”, the selector 224 selects the shifter 221 as an input source. When the selector control signal C1 indicates “left shift”, the selector 224 selects the shifter 222 as an input source. When the selector control signal C1 indicates “right shift”, the selector 224 selects the shifter 223 as an input source.

### <Bidirectional 8-Bit Shifter 230>

The bidirectional 8-bit shifter 230 includes shifters 231, 232, 233, 234, and 235, and the selector 236. The bidirectional 8-bit shifter 230 generates 44-bit data from the 38-bit data outputted from the bidirectional 3-bit shifter 220, and outputs the generated 44-bit data.

At this point, the shifter 231 does not shift the 38-bit data outputted from the selector 224 but adds three bits to both sides of the data (six bits in total), so that the 44-bit data is generated.

The shifter 232 shifts, to the left by eight bits, the 38-bit data outputted from the selector 224, so that the 44-bit data is generated.

The shifter 233 shifts, to the right by eight bits, the 38-bit data outputted from the selector 224, so that the 44-bit data is generated.

The shifter 234 rotates, to the left by eight bits, only a portion (32-bit data) other than three bits on both sides of the 38-bit data outputted from the selector 224, so that the 44-bit data is generated.

The shifter 235 rotates, to the right by eight bits, only a portion (32-bit data) other than three bits on both sides of the 38-bit data outputted from the selector 224, so that the 44-bit data is generated.

The selector 236 selects one of the shifters 231,232, 233, 234, and 235 as an input source based on the selector control signal C2 outputted from the decoder 204, and outputs the 44-bit data generated by the selected input source.

For example, when the selector control signal C2 indicates “non-shift”, the selector 236 selects the shifter 231 as an input source. When the selector control signal C2 indicates “left shift”, the selector 236 selects the shifter 232 as an input source. When the selector control signal C2 indicates “right shift”, the selector 236 selects the shifter 233 as an input source. When the selector control signal C2 indicates “left rotation”, the selector 236 selects the shifter 234 as an input source. When the selector control signal C2 indicates “right rotation”, the selector 236 selects the shifter 235 as an input source.

### <Bidirectional 19-Bit Shifter 240>

The bidirectional 19-bit shifter 240 includes shifters 241, 242, and 243, and the selector 244. The bidirectional 19-bit shifter 240 generates 32-bit data from the 44-bit data outputted from the bidirectional 8-bit shifter 230, and outputs the generated 32-bit data.

At this point, the shifter 241 does not shift the 44-bit data outputted from the selector 236 but deletes six bits from both sides of the data (12 bits in total), so that the 32-bit data is generated.

The shifter 242 shifts, to the left by 19 bits, the 44-bit data outputted from the selector 236 and deletes six bits from both sides of the data (12 bits in total), so that the 32-bit data is generated.

The shifter 243 shifts, to the right by 19 bits, the 44-bit data outputted from the selector 236 and deletes six bits from both sides of the data (12 bits in total), so that the 32-bit data is generated.

The selector 244 selects one of the shifters 241, 242, and 243 as an input source based on the selector control signal C3 outputted from the decoder 204, and outputs the 32-bit data generated by the selected input source.

For example, when the selector control signal C3 indicates “non-shift”, the selector 244 selects the shifter 241 as an input source. When the selector control signal C3 indicates “left shift”, the selector 244 selects the shifter 242 as an input source. When the selector control signal C3 indicates “right shift”, the selector 244 selects the shifter 243 as an input source.

### <Operation>

With this operation, the 32-bit data (input data I) stored in the input data register unit 101 passes through the bidirectional 1-bit shifter 210, the bidirectional 3-bit shifter 220, the bidirectional 8-bit shifter 230, the bidirectional 19-bit shifter 240, and the selector 206, so that one of a shift operation and endian conversion is performed on the data. The 32-bit data (output data O) obtained by one of the shift operation and endian conversion is stored in the output data register unit 102.

### <Barrel Shifter>

The following will describe the barrel shifter included in the information apparatus 200.

In the barrel shifter included in the information apparatus 200, necessary data is obtained by a combination of a right shift and a left shift. However, data in the bit shifter has to be outputted to the subsequent bit shifter with data to be shifted out. Thus the data outputted from the bit shifter includes unnecessary bits (hereinafter, will be referred to as additional bits).

For example, in order to perform a shift operation of a left shift 31-bit to a right shift 31-bit in the barrel shifter, the following operations (1) to (3) are performed:

(1) In the bidirectional 1-bit shifter 210, the output side is expanded to both sides by one bit relative to the input side.
(2) In the bidirectional 3-bit shifter 220, the output side is expanded to both sides by two bits relative to the input side.
(3) In the bidirectional 8-bit shifter 230, the output side is expanded to both sides by three bits relative to the input side.

In this case, in the data outputted from the bit shifters, portions corresponding to the 32-bit data (input data I) are obtained as will be described in (1) to (4) below.

(1) The data outputted from the bidirectional 1-bit shifter 210 includes additional bits (one bit on both sides). Thus the corresponding portion in the data outputted from the bidirectional 1-bit shifter 210 is data [32:1] other than the additional bits (one bit on both sides).
(2) The data outputted from the bidirectional 3-bit shifter 220 includes additional bits (three bits on both sides). Thus the corresponding portion in the data outputted from the bidirectional 3-bit shifter 220 is data [34:3] other than the additional bits (three bits on both sides).
(3) The data outputted from the bidirectional 8-bit shifter 230 includes additional bits (six bits on both sides). Thus the corresponding portion in the data outputted from the bidirectional 8-bit shifter 230 is data [37:6] other than the additional bits (six bits on both sides).
(4) The data outputted from the bidirectional 19-bit shifter 240 does not include additional bits. Thus the corresponding portion in the data outputted from the bidirectional 19-bit shifter 240 is data [31:0].

### <Truth Table>

The following will describe the truth table of the control signals as to operations indicating the actions of the information apparatus 200.

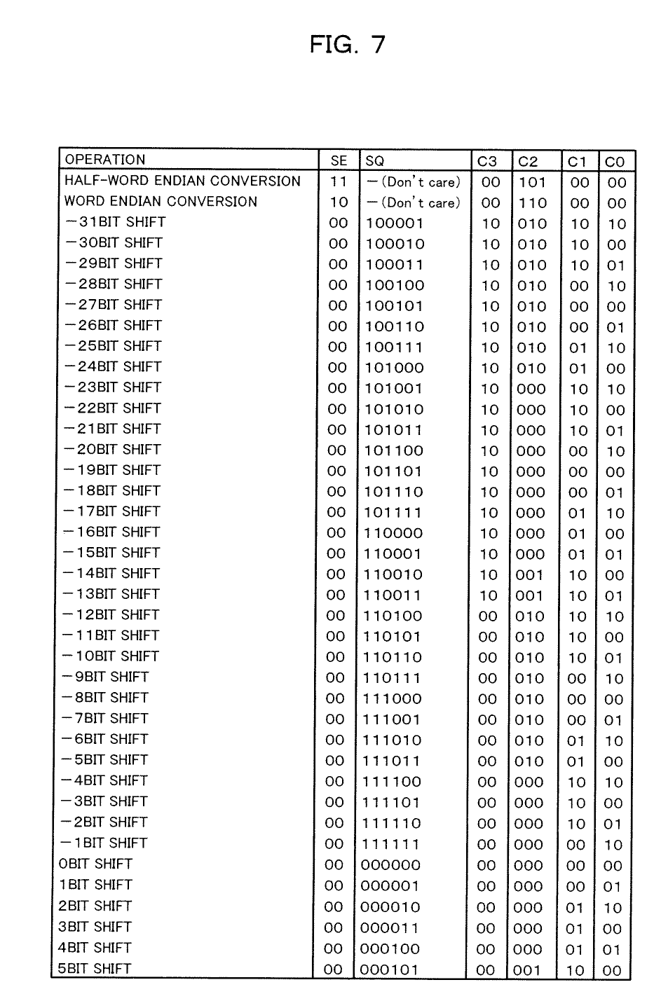

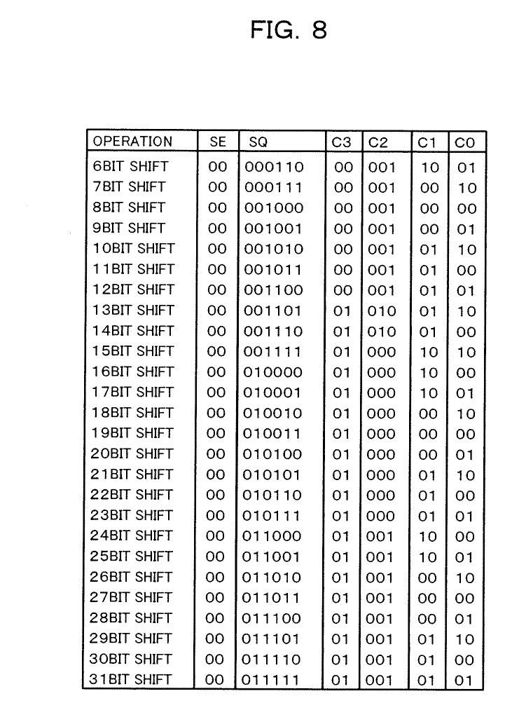

FIG. 7 shows the truth table of the control signals as to endian conversion on half-word data (hereinafter, will be referred to as half-word endian conversion), endian conversion on word data (hereinafter, will be referred to as word endian conversion), and a shift operation of a right shift 31-bit to a left shift 5-bit. FIG. 8 shows the truth table of the control signals as to a shift operation of a left shift 6-bit to a left shift 31-bit.

The truth values of the shift quantity control signal SQ are uniquely assigned values of −31 to 31. In this case, negative numbers indicate right shifts and positive numbers indicate left shifts.

As shown in FIGS. 7 and 8, as to the selector control signals C0, C1, and C3, “00” represents “non-shift”, “01” represents “left shift”, and “10” represents “right shift”. As to the selector control signal C2, “000” represents “non-shift”, “0011” represents “left shift”, “010” represents “right shift”, “101” represents “left rotation”, and “110” represents “right rotation”. As to the endian control signal SE, “11” represents “half-word endian conversion” and “10” represents “word endian conversion”.

For example, in a shift operation, the control unit 103 outputs the endian control signal SE(00). In endian conversion, the control unit 103 outputs the endian control signal SE (one of 10 and 11).

At this point, in the case of word endian conversion, the control unit 103 outputs the endian control signal SE(10) to the decoder 204. Accordingly, the decoder 204 outputs the selector control signal C2 (110) to the bidirectional 8-bit shifter 230. The bidirectional 8-bit shifter 230 is caused to output data of an 8-bit right rotation.

In the case of half-word endian conversion, the control unit 103 outputs the endian control signal SE(11) to the decoder 204. Accordingly, the decoder 204 outputs the selector control signal C2(101) to the bidirectional 8-bit shifter 230. The bidirectional 8-bit shifter 230 is caused to output data of an 8-bit left rotation.

When the value of the endian control signal SE[1] is “0”, the selector 206 selects the bidirectional 19-bit shifter 240 as an input source. When the value of the endian control signal SE[1] is “1”, the selector 206 selects the endian conversion unit 205 as an input source.

### <Endian Conversion>

The following will describe endian conversion in the information apparatus 200.

First, the endian conversion unit 205 is fed with 32-bit data S8 [37:6] obtained by excluding the additional bits (six bits on both sides) from the data S8 outputted from the bidirectional 8-bit shifter 230.

Accordingly, the endian conversion unit 205 generates data by sequentially arranging the inputted 32-bit data S8 [37:6] from the least significant byte such that the third byte of the data S8 (S8 [29:22]), the second byte of the data S8 (S8 [21:14]), the first byte of the data S8 (S8 [13:6]), and the fourth byte of the data S8 (S8 [37:30]) are sequentially arranged.

Thus from the endian conversion unit 205, data {S8 [37:30], S8 [13:6], S8 [21:14], S8 [29:22]} is outputted.

At this point, when expressed in the input data I in the case of word endian conversion, data {I[7:0], I[31:24], I[23:16], I[15:8]} is inputted to the endian conversion unit 205. The inputted data {I[7:0], I[31:24], I[23:16], I[15:8]} is converted to data {I[7:0], I[15:8], I[23:16], I[31:24]} in the endian conversion unit 205. The converted data {I[7:0], I[15:8], I[23:16], I[31:24]} is outputted from the endian conversion unit 205. In other words, it is possible to obtain a result of word endian conversion on the input data I.

In the case of half-word endian conversion, when expressed in the input data I, data {I[23:16], I[15:8], I[7:0], I[31:24]} is inputted to the endian conversion unit 205. The inputted data {I[23:16], I[15:8], I[7:0], I[31:24]} is converted to data {I[23:16], I[31:24], I[7:0], I[15:8]} in the endian conversion unit 205. The converted data {I[23:16], I[31:24], I[7:0], I[15:8]} is outputted from the endian conversion unit 205. In other words, it is possible to obtain a result of half-word endian conversion on the input data I.

### Conclusion

As has been discussed, according to the present embodiment, the information apparatus 200 controls the barrel shifter, which is necessary for aligning digits during the execution of a shift instruction, an operation instruction, and so on, by means of the control unit 103, the decoder 204, and the selector 206, so that a shift operation and endian conversion can be selectively performed. Consequently, it is not necessary to provide an endian converter, thereby suppressing an increase in circuit. Further, it is not necessary to provide an endian converter for each kind of endian conversion, thereby suppressing an increase in circuit.

### (Others)

The information apparatus of the present invention may be realized by a full-custom large scale integration (LSI). Further, the information apparatus may be realized by a semi-custom LSI such as an application specific integrated circuit (ASIC). Moreover, the information apparatus may be realized by a programmable logic device such as a field programmable gate array (FPGA) and a complex programmable logic device (CPLD). The information apparatus may be also realized as a dynamic reconfigurable device having a dynamically rewritable circuit configuration.

Further, design data for configuring, in these LSIs, at least one function composing the information apparatus of the present invention may be a program (hereinafter, will be referred to as an HDL program) described in a hardware description language such as a very high-speed integrated circuit hardware description language (VHDL), Verilog-HDL, and SystemC. The HDL program may be a net list at a gate level obtained by performing logic synthesis on the HDL program. Further, the HDL program may be macro cell information obtained by adding layout information, process conditions, and so on to the net list of the gate level. Moreover, the HDL program may be mask data including specified dimensions and timing.

The design data may be recorded on a recording medium readable by a hardware system such as a computer system and an embedded system. Further, design data read by another hardware system through a recording medium may be downloaded to a programmable logic device via a download cable. Thus the information apparatus of the present invention can be realized in another hardware system. The recording medium readable by a hardware system includes an optical recording medium (e.g., a CD-ROM), a magnetic recording medium (e.g., a hard disk), a magneto-optical recording medium (e.g., an MO disk), and a semiconductor memory (e.g., a memory card).

Design data may be stored in a hardware system connected to a network such as the Internet and a local area network. Further, design data obtained by another hardware system via a network may be downloaded to a programmable logic device through a download cable. Thus the information apparatus of the present invention can be realized in another hardware system. The network includes a terrestrial network, a satellite network, a power line communication (PLC), a mobile network, a cable network (e.g., IEEE802.3), and a wireless network (e.g., IEEE802.11).

Design data having undergone logic synthesis, placement, and wiring may be recorded on serial ROM. Further, the design data recorded on the serial ROM may be directly downloaded to an FPGA when applying current.

The embodiments of the present invention having been described in detail are to be merely taken as examples, and it is easily understood by a person skilled in the art that various changes can be made in the embodiments of the present invention. Thus various changes in the embodiments of the present invention are all included within the scope of the present invention.

The present invention can be used as an information apparatus and the like for performing a shift operation and endian conversion with a barrel shifter.

What is claimed is:

1. An information apparatus, comprising:
a barrel shifter composed of a plurality of bit shifters connected in series in a direction of a data flow;
a control unit for outputting a control signal indicating one of a first operation for bit shifting data and a second operation for converting data from first endian to second endian;
an endian conversion unit for generating data by performing the second operation using data obtained by performing a shift operation in one of the bit shifters of the barrel shifter; and
a selector for outputting, when the control signal indicates the first operation, data obtained by performing a shift operation in all the bit shifters of the barrel shifter, and outputting, when the control signal indicates the second operation, the data generated in the endian conversion unit.

2. The information apparatus according to claim 1, wherein the barrel shifter is composed of a bidirectional 1-bit shifter, a bidirectional 3-bit shifter, a bidirectional 8-bit shifter, and a bidirectional 24-bit shifter which are sequentially connected in series from a side fed with 32-bit first data,
the bidirectional 1-bit shifter generates 34-bit second data by performing a shift operation on the first data,
the bidirectional 3-bit shifter generates 38-bit third data by performing a shift operation on the second data,
the bidirectional 8-bit shifter generates 54-bit fourth data by performing a shift operation on the third data,
the bidirectional 24-bit shifter generates 32-bit fifth data by performing a shift operation on the fourth data,
the endian conversion unit generates sixth data by sequentially arranging first byte data of the fifth data, second byte data of a portion obtained by excluding 11 bits on both sides from the fourth data, third byte data of the fifth data, and fourth byte data of the portion obtained by excluding 11 bits on both sides from the fourth data, and
the selector outputs, when the control signal indicates the first operation, the fifth data as data obtained by performing a shift operation in all the bit shifters of the barrel shifter, and outputs, when the control signal indicates the second operation, the sixth data as the data generated in the endian conversion unit.

3. The information apparatus according to claim 2, further comprising a decoder for controlling a shift operation in each of the bit shifters of the barrel shifter based on the control signal outputted from the control unit,
wherein in endian conversion on word data when the control signal indicates the second operation, the decoder causes:
the bidirectional 1-bit shifter to output a result of non-shift as the second data,
the bidirectional 3-bit shifter to output a result of non-shift as the third data,
the bidirectional 8-bit shifter to output a result of right rotation as the fourth data, and
the bidirectional 24-bit shifter to output a result of right rotation as the fifth data, and
in endian conversion on half-word data when the control signal indicates the second operation, the decoder causes:
the bidirectional 1-bit shifter to output a result of non-shift as the second data,
the bidirectional 3-bit shifter to output a result of non-shift as the third data,
the bidirectional 8-bit shifter to output a result of left rotation as the fourth data, and
the bidirectional 24-bit shifter to output a result of left rotation as the fifth data.

4. The information apparatus according to claim 1, wherein the barrel shifter is composed of a bidirectional 1-bit shifter, a bidirectional 3-bit shifter, a bidirectional 8-bit shifter, and a bidirectional 19-bit shifter which are sequentially connected in series from a side fed with 32-bit first data,
the bidirectional 1-bit shifter generates 34-bit second data by performing a shift operation on the first data,
the bidirectional 3-bit shifter generates 38-bit third data by performing a shift operation on the second data,
the bidirectional 8-bit shifter generates 44-bit fourth data by performing a shift operation on the third data,
the bidirectional 19-bit shifter generates 32-bit fifth data by performing a shift operation on the fourth data,
the endian conversion unit generates sixth data by sequentially arranging third byte data, second byte data, first byte data, and fourth byte data in a portion obtained by excluding six bits on both sides from the fourth data, and
the selector outputs, when the control signal indicates the first operation, the fifth data as data obtained by performing a shift operation in all the bit shifters of the barrel shifter, and outputs, when the control signal indicates the second operation, the sixth data as the data generated in the endian conversion unit.

5. The information apparatus according to claim 4, further comprising a decoder for controlling a shift operation in each of the bit shifters of the barrel shifter based on the control signal outputted from the control unit,
wherein in endian conversion on word data when the control signal indicates the second operation, the decoder causes:
the bidirectional 1-bit shifter to output a result of non-shift as the second data,
the bidirectional 3-bit shifter to output a result of non-shift as the third data,
the bidirectional 8-bit shifter to output a result of right rotation as the fourth data, and
the bidirectional 19-bit shifter to output a result of non-shift as the fifth data, and
in endian conversion on half-word data when the control signal indicates the second operation, the decoder causes:
the bidirectional 1-bit shifter to output a result of non-shift as the second data,
the bidirectional 3-bit shifter to output a result of non-shift as the third data,
the bidirectional 8-bit shifter to output a result of left rotation as the fourth data, and
the bidirectional 19-bit shifter to output a result of non-shift as the fifth data.
